(19) United States
(12) Patent Application Publication
(10) Pub. No.: US 2025/0029172 A1
(43) Pub. Date: Jan. 23, 2025

(54) ARTIFICIAL INTELLIGENCE TECHNIQUE FOR SOURCE METRIC BASED ON STRETCHED NORMALIZATION

(71) Applicant: Oracle International Corporation, Redwood Shores, CA (US)

(72) Inventors: Suresh Kumar Golconda, Santa Clara, CA (US); Amit Arora, Fremont, CA (US)

(73) Assignee: Oracle International Corporation, Redwood Shores, CA (US)

(21) Appl. No.: 18/355,994

(22) Filed: Jul. 20, 2023

(51) Int. Cl. G06Q 30/0601

(52) U.S. Cl. CPC G06Q 30/0641

(57) ABSTRACT

The present disclosure relates to systems and methods for using an artificial intelligence technique for determining a source score based on stretched normalization. A natural language query can be received and mapped. Sources can be identified, and actions can be taken with respect to each source. The actions can include determining an item-source metric, transforming the item-source metric using a stretched-normalization factor, and generating a source score based on the transformed item-source metric. A response to the natural language query can be generated based on the source score, and the response can be output.

### TECHNICAL FIELD

The present disclosure relates generally to artificial intelligence techniques. More particularly, the present disclosure relates to systems and methods that involve using an artificial intelligence technique for determining a source metric based on stretched normalization.

### BACKGROUND

Frequently, users submit queries that correspond to a request for an item to be provided. Various sources may provide the item. However, there may be different extents to which the item that a source is configured to provide matches or corresponds to an item being requested. Further, various sources may differ in a degree to which a quality of the provided item, a speed of a transport, or amounts requested for the item, etc.

Therefore, backend processing may be performed to attempt to predict which source is likely to provide an item in a manner and have characteristics that conform with priorities associated with the request. Such processing may use metadata, historical data (e.g., tracking transport speed), current item-listing data, reviews, etc. The processing may result in determining a subset of sources or a ranking of sources, either or both of which can be used to generate a response to a query. For example, a response to the query may selectively identify sources (e.g., and items that the sources are configured to provide that correspond to the query) when one or more conditions are met (e.g., transport speed exceeding a threshold, a degree of match between the provided item and a query-identified item exceeding a threshold, etc.). As another example, a response to the query may identify sources (and/or corresponding items) in an order that is based on a ranking that depends on one or more of the aforementioned characteristics.

However, in some instances, a user may be interested in receiving multiple items. It may be advantageous for the user and/or for one or more sources to prioritize a degree to which each of one or more sources may provide multiple items in the set of items. For example, if two items were individually considered, a user may decide to initiate provision of each of the items from different sources. However, this may result in transport inefficiency, potential item interoperation problems, item clashing, etc.

### SUMMARY

In some embodiments, a computer-implemented method is provided. A natural-language query is received from a requestor system. The natural-language query includes, for each item of a set of items, a natural language identification of the item. For each item of the set of items, the natural-language identification of the item is mapped to an item category using an artificial-intelligence model that includes a natural language processing model. A set of sources is identified, where each source of the set of sources is configured to, for at least one item of the set of items, provide an item that corresponds to an item category mapped to the item. One or more target ranges for source scores, wherein each target range of the one or more target ranges is from a corresponding target range minimum to a corresponding target-range maximum. For each source of the set of sources and for each item of the at least one of the set of items that the source is configured to provide, an item-source metric is determined that predicts a degree to which a predicted provision of the item by the source accords with requestor priorities of a provision of the item, wherein the item-source metric includes a number within an item-score range. For each source of the set of sources and for each item of the at least one of the set of items that the source is configured to provide, the item-source metric is transformed to a stretch-normalized item-source metric by generating a product of the item-source metric and a stretched-normalization factor that is based on a ratio of a size of a target range of the one or more target ranges relative to a maximum of the item-source metrics across the set of sources. For each source of the set of sources, a source score is generated using the stretched-normalization item-source metrics associated with the source. A response to the query is generated based on the source scores. The response to the query is output.

The method may further include receiving, via an interface, input from the requestor system that indicates a relative priority of a source characteristic for evaluating the set of sources, wherein the source score generated for each source of the set of sources is further based on the relative priority of the source characteristic.

The degree to which the predicted provision of the item by the source accords with the requestor priorities of the provision of the item may be based on a degree to which the item that the source is configured to provide is the same as the item identified in the set of items.

The degree to which the predicted provision of the item by the source may accord with the requestor priorities of the provision of the item is based on a predicted probability of the item being available for the source to transport, the predicted probability being based on empirical indications as to whether or with what delay another item of a same type was received from the source by another requester.

The degree to which the predicted provision of the item by the source may accord with the requestor priorities of the provision of the item is determined by generating, using a machine-learning model, a predicted requestor rating of provision of the item by the source.

The method may include ranking the set of sources based on the source scores, wherein the response includes an identification of the set of sources and the ranking of the set of sources.

The method may include ranking the set of sources based on the source scores; and determining an incomplete subset of the set of sources, wherein the response includes an identification of the incomplete subset of the set of sources.

A quantity of items in the at least one item of the set of items that a first source of the set of sources may be configured to provide is different than a quantity of items in the at least one item of the set of items that a second source of the set of sources is configured to provide, and the response to the query may indicate which items of the set of items that the first source is configured to provide and which items of the set of items that the second source is configured to provide.

The method may include, for each source of the set of sources: for each item of any items that are in the set of items but for which the source is not configured to provide: assigning a default value as a stretch-normalized item-source metric, wherein the default value is a predefined constant or is based on the stretch-normalized item-source metrics associated with one or more other sources of the set of sources and associated with the item; and wherein generating the source score includes: generating a statistic based on the stretch-normalized item-source metrics for the set of items.

For each source of the set of sources, the source score generated for the source may be selectively based on the at least one of the set of items that the source is configured to provide.

In some instances, the transformation of the item-source metric to the stretch-normalized item source metric does not use a minimum of the item-source metrics across the set of sources.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The specification makes reference to the following appended figures, in which use of like reference numerals in different figures is intended to illustrate like or analogous components.

FIG. 1 is a block diagram illustrating an example of a computing environment for using an artificial intelligence technique for determining a source metric based on stretched normalization according to an embodiment.

FIG. 2 is a flowchart of a process for using an artificial intelligence technique for determining a source metric based on stretched normalization according to an embodiment.

FIG. 3 is an example of a data flow diagram for using an artificial intelligence technique for determining a source metric based on stretched normalization according to an embodiment.

FIG. 4 illustrates an exemplary user interface configured to receive identification of items being requested and various prioritizations according to an embodiment.

FIG. 5 illustrates an exemplary user interface configured to present preliminary source data corresponding to a request for a set of items and to receive prioritization-modifications to trigger source-identification updates according to an embodiment.

FIG. 6 illustrates an exemplary user interface configured to present preliminary source data corresponding to a request for a set of items and to receive prioritization-modifications to trigger source-identification updates according to an embodiment.

FIG. 7 is a simplified diagram illustrating a distributed system for implementing one of the embodiments.

FIG. 8 is a simplified block diagram illustrating one or more components of a system environment according to an embodiment.

FIG. 9 illustrates an exemplary computer system, in which various embodiments of the present invention may be implemented.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Overview

Certain aspects and features of the present disclosure relate to using an artificial intelligence technique for performing custom searches using stretched normalization so as to implement custom prioritizations of items and/or other factors, as identified via input from a requestor system. Certain aspects and features of the present disclosure relate to a dynamic graphical user interface that receive and dynamically adapt to new or changed item lists and/or new or changed prioritizations so as to provide information about a single source or a given combination of sources predicted to comply (e.g., absolutely or to a given relative or absolute extent) with the items and prioritizations).

In some embodiments, backend and/or frontend technologies are provided to facilitate efficiently and intelligently responding to a request from a requestor system to provide multiple items. The request may include a natural-language request that identifies each of the multiple items using natural language. A response may selectively identify one or more results, where each result may identify one or more sources that are configured to individually or collectively (respectively) provide the multiple items. The one or more results may be ranked. The selective identification of the results and/or the ranking may be based on characteristics associated with various sources and/or prioritizations received from the requestor system (and/or default prioritizations).

A natural-language identification of an item in a query may fail to precisely equate to an identification of an item for which a source is configured to provide. Accordingly, embodiments disclosed herein may involve predicting whether and/or an extent to which each of multiple items for which multiple sources are configured to provide correspond to or match the item(s) identified in the natural-language request. In addition to or instead of the predicted extent of correspondence or match, one or more characteristics of the source may be identified and assessed in view of one or more target characteristics associated with the requestor system and/or in view of one or more item-constraint conditions associated with the requestor system. For example, a transport speed, a transport-speed reliability, an efficient item amount, a reliable transport quality, a sustainability and/or one or more other item-provision characteristics may be prioritized and/or required generally and/or with regard to specific requestor system. In some instances, such prioritizations or constraints may be applied across all items requested by a given requestor system, such as in a single request or across all requests, or may be different.

Predicting provision details is more complicated when a request identifies multiple items. For example, the uncertainty as to whether an item for which a source is configured to provide matches or corresponds to a requested item can exponentially expand as more items are simultaneously requested. Similarly, a certainty of an absolute value or a degree to which a predicted characteristic value accords with a target value of the characteristic (e.g., a target quality, a transport speed, etc.) may differ across items in a set of items as it relates to a potential source.

Various embodiments provided herein relate to using an artificial-intelligence technique to facilitate processing a request for provision of multiple items to be provided by one or more sources, particularly in a manner that structures or fine-tunes a loss function or fine-tuning to selectively weight overall or item-specific priorities in accordance with specifications as identified by an entity such as a client. For example, an interface may be provided that includes input elements that are configured to received inputs that indicate a relative or absolute degree to which various item-provision characteristics are to be prioritized, for example relative to other item-provision characteristics pertaining to a same and/or other items. To illustrate, a user device may interact with an interface to indicate that a strong item match is particularly important (e.g., a 100-point item-match priority) for a given item in the multiple items and that a fast transport is of high importance, though the item-match prediction is less importance (e.g., a 90-point transport-speed priority and a 70-point item-match priority).

The artificial-intelligence technique may include one or more machine-learning model implementations. For example, an initial query may include a natural-language identification of each of multiple items. For example, for each of multiple items, one or more words can identify an item that is being requested. A natural-language processing technique can be used to map the natural-language identification to a keyword, a cluster, a category, a term predicted to represent a same or similar meaning, etc. For example, the natural-language processing technique may include a generative model, a Transformer model, a bidirectional encoder representations from transformers (BERT) model, a Word2Vec model, and the like, that may be used to map a given natural-language identification to a representation in a common dimensional space, which may then be used to identify a cluster, near or nearest neighbor, distance metric, etc., or that may be used to directly identify a cluster assignment, category assignment, one or more nearest neighbors, probability of a given metric, such as an item-provision success metric prediction, etc. The generative model may be or include a generative adversarial network (GAN) or other suitable generative model that can predict, for example, subsequent words from a sequence of words. The Transformer model may be or include a deep learning model or other suitable Transformer model that can process input natural language to determine context and meaning from the input. The BERT model can include any suitable BERT model, which may include one or more Transformer models or layers, that can be or included masked architectures for determining context, meaning, and the like from natural language input. The Word2Vec model may be or include a neural network that can output word associations based on natural language input and training based on a large corpus of text.

In some instances, the natural-language processing technique may integrate weighting one or more other predictions that relate to predicted item provisions by a source. In some instances, predicted item provisions for a source are incorporated as a post-processing layered on top of the natural-language processing. The predicted item provisions may include, for example, a likelihood that a given source does or will avail an item that is configured to provide (e.g., based on a mapping of a natural-language input to a nearest neighbor, a predefined category mapped to the input), that a given source has access an item to provide (e.g., based on real-time availability information from the source and/or empirical data from one or more other users that indicate a time delay or success of a delivery), a predicted transport time for an item by a source, an amount that would be collected by a source for providing and transporting and providing a source, a degree to which two or more items of the multiple items have a matching style or color, etc. One or more of the predicted item provisions may be based on input, which may have been provided anonymously or pseudo-anonymously, provided by one or more other users for which the source was to provide at least one of the set of items.

The artificial-intelligence technique may include one or more assessments, one or more models, one or more layers, and/or one or more post-processing techniques that are configured to process a query that identifies multiple items. The identification of each of the multiple items may include a natural-language identification of the item. The technique may include, for example, mapping the identification of each item to a category, term, cluster, semantic meaning, etc. In some instances, the identification of each of one or more of the multiple items is transformed or projected into a multi-dimensional space, where each of a set of item categories is also assigned to a position or region in the multi-dimensional space. An item that is identified in a user request can then be mapped to an item category based on, for example, identifying which item category corresponds to a position or region that is closest to the projection of the requested item. Sources that provide an item corresponding to the item category can then be identified (e.g., based on a distance-based approach, gradient approach, nearest-neighbor approach, clustering approach, etc.). Alternatively or additionally, each item for which one or more sources is configured to provide may be mapped into the multi-dimensional space, and one or more items availed by one or more sources may be associated with a request item based on distances between the projection of the requested item and a projection of each of the one or more items being below a threshold.

### Example of a Computing Environment for Determining a Source Metric Using Artificial Intelligence

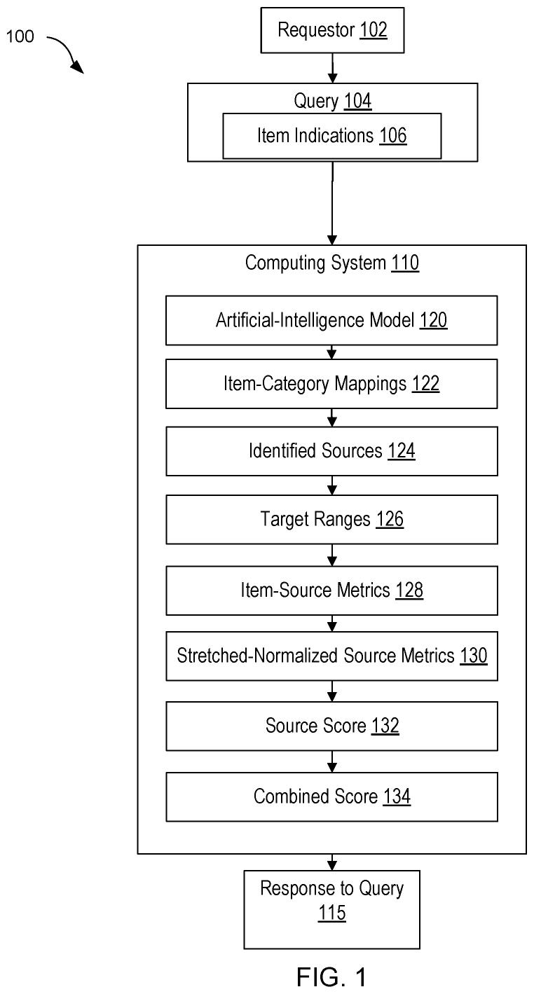

FIG. 1 is a block diagram illustrating an example of a computing environment 100 for using an artificial intelligence technique for determining a source metric based on stretched normalization according to an embodiment. As illustrated, the computing environment 100 includes at least a requestor 102, a query 104, a computing system 110, and a response to the query 115, though the computing environment can include any other components for using an artificial intelligence technique for determining a source metric based on stretched normalization.

The requestor 102 may be or include a requestor system, such as a personal computing device, a mobile computing device, a computer server, a server farm, or the like that may be operated by an entity such as a client. The client may be interested in provisioning, procuring, or otherwise acquiring one or more items, such as computing hardware, computing resources, manufactured goods, services, and the like, and the requestor 102 can generate and submit the query 104 to the computing system 110. The requestor 102 can generate the query 104 using natural language descriptions. For example, the query 104 can include natural language representations of item indications 106. Examples of the item indications 106 can include natural language phrases, words, or strings such as “computers,” “computer hardware,” “wooden desks,” “computer memory,” “digital storage,” “monitors,” “air conditioners,” and any other suitable example for the item indications 106. The requestor 102 can transmit the query 104 having the item indications 106 to the computing system 110 to solicit a response, such as the response to query 115, that can indicate one or more sources that can provide one or more, or all, of the items corresponding to the item indications 106. In some instances, the response includes multiple results—each of which identifies one or more sources configured to provide a part or all of the items corresponding to the item indications 105. Computing system 110 may determine or predict whether each source is configured to provide or can provide any given item based on (for example) a look-up table, web-crawling, prior messages pertaining to the source and item, etc.

The computing system 110 can receive the query 104 and can use at least the item indications 106 as input into an artificial intelligence model 120. The artificial intelligence model 120 can be or include a machine-learning model, a deep learning model, a neural network model, a natural language processing model, and the like. In some particular examples, the artificial intelligence model 120 can be, include, or involve using a generative model, a clustering model (e.g., a component-analysis model), a Transformer model, a nearest neighbor model, etc. In some embodiments, the nearest neighbor model, or any other model or combination thereof, may be a parallelized model such as the parallel nearest neighbor model, as described in U.S. application Ser. No. 18/314,880, filed May 10, 2023, which is hereby incorporated by reference in its entirety for all purposes.

The artificial intelligence model 120 can be or include a natural language processing model that can be configured to perform one or more natural language processing techniques. For example, the artificial intelligence model 120 can be configured to receive natural language input, such as the item indications 106, and can be configured to output one or more mappings such as item-category mappings 122. The artificial intelligence model 120 can identify one or more items indicated by the item indications 106 and can map each item of the one or more items to a category, such as item-category mappings 122, corresponding to the item. For example, if a particular item indication indicates that a particular item is a wooden desk, then the artificial intelligence model 120 can map the particular item to an item category, such as “furniture,” to generate the corresponding item-category mapping.

The computing system 110, or any component or subset thereof, can identify a set of sources. The identified sources 124 can be or include one or more sources configured to provide one or more items indicated by the item indications 106 and/or the item-category mappings 122. In some embodiments, the computing system 110 can query a database, a webpage, or the like to identify the set of sources. In a particular example, the computing system 110 may access the Internet and submit a query, for example to a search engine, to identify one or more sources of the set of sources that can provide one or more of the items. In another embodiment, the computing system 110 may access or query a database that includes indications of one or more sources that may be configured to provide one or more items associated with the item indications 106 and/or the item-category mappings 122. Additionally, each source of the set of sources may be configured to, for at least one item of the set of items, provide an item that corresponds to an item category mapped to the item and included in the item-category mappings 122.

In some embodiments, the computing system 110, or any component or subset thereof, can determine target ranges 126 for the identified sources 124. The target ranges 126 may correspond to source scores for the set of sources. For example, each source of the set of sources may have a corresponding source score that can indicate a likelihood of providing an item subject to certain parameters such as client-specified parameters, third-party-determined parameters, and the like. The computing system 110 can determine each target range of the one or more target ranges in a corresponding target-range minimum to a corresponding target-range maximum. For example, and for a particular source of the set of sources, the computing system 110 can determine a target-range minimum source score and can determine a target-range maximum source score. The target-range minimum source score and the target-range maximum source score can be the minimum possible score and the maximum possible score for the corresponding source. In other examples, the target-range minimum source score and the target-range maximum source score can be the minimum acceptable score and/or the maximum acceptable score for the source, for example based on parameters specified by the query 104.

The computing system 110 can use the item indications 106, the item-category mappings 122, and/or the identified sources 124 to determine item-source metrics 128. For example, and for each source of the identified sources 124, the computing system 110 can generate an item-source metric (e.g., included in the item-source metrics 128) that can predict a degree to which a predicted provision or procurement of the corresponding item by the corresponding source accords with requestor priorities of a provision of the corresponding item. The requestor priorities may be included in the query 104 (or may be separately provided in a query-specific or cross-query manner) and may indicate or include target item-provision parameters for provisioning the corresponding item. In a particular example, the target item-provision parameters may include an amount of resources to provision the corresponding item, a time to provision the corresponding item, a match percentage (e.g., to a requested item) of the corresponding item to be provisioned, and the like. The item-source metrics 128 may each be within range for the item (e.g., predefined for the item or observed across metrics for the item associated with different sources), which may be similar or identical to the corresponding target range of the target ranges 126, though the metric range may, in other examples, be different than the corresponding target range.

Additionally, and for each source of the set of sources, the computing system 110 can transform the item-source metrics 128 to a stretched-normalization item-source metric 130. The computing system 110 may generate the stretched-normalization item-source metric 130 by (for example) determining a multiplication product between the item-source metric and a stretched-normalization factor, where the stretched-normalization factor may be based on a ratio of a size of a target range of the target ranges 126 relative to a maximum item-source metric among the item-source metrics 128. In some embodiments, the transformation of the item-source metric to the stretch-normalized item source metric may not use a minimum of the item-source metrics across the set of sources. The stretched-normalization factor may be other suitable factors for stretch-normalizing the item-source metrics 128 to generate the stretched-normalization item-source metrics. Additionally, the computing system 110 can, for each source of the set of sources, generate stretch-normalized item-source metrics 130 using the stretched-normalization item-source metrics. The stretch-normalized item-source metric 130 can indicate a likelihood of the respective source providing the respective item consistent with the requestor priorities or other parameters relating to provisioning or procuring the one or more requested items.

A source score 132 can be generated for each of one or more sources. A source score may be defined to be (for example) a statistic (e.g., an average, weighted average, median, weighted median, mode, weighted mode, minimum, or maximum) defined based on one or more stretched-normalization source metrics 130. The one or more stretched-normalization source metrics 130 may be (for example): each and all stretched-normalization source metric associated with the source, each and all stretched-normalization source metric associated both with the source and the items being requested, at least one (e.g., a maximum or minimum) stretched-normalization source metric associated with the source, at least one (e.g., a maximum or minimum) stretched-normalization source metric 130 associated both with the source and the items being requested, etc. The source score 132 may be generated based on one or more weightings (e.g., that may correspond to prioritization indications provided by a client). For example, if the item indications 106 was accompanied with query data that indicated that Item #1 was associated with a priority of 100, and Item #2 was associated with a priority of 50, the source score 132 may weight stretch-normalized item-source metrics 130 accordingly. It will be appreciated that there may be some source-level data points, which may either be incorporated into or reflected in item-source metrics 128, stretch-normalized item-source metrics, or source score 132. For example, a delivery speed may—or may not—be dependent on and/or tracked for various types of items.

A combined score 134 can be generated that pertains to a given request. For example, if a request includes 20 items, it may—or may not—be possible to receive all of the items from a given source. Alternatively, various subsets of the items may be provided from different sources. The combined score 134 may be defined to be (for example): a lowest, highest, mean, median or mode source score 132 associated with a given result; a weighted average of source scores 132 and/or stretched-normalization source metrics 130 (e.g., where the weighting is based on prioritizations, number of items associated with a source, etc.), and so on.

A response to the query may include one or more source scores 132, one or more combined scores 134, and/or one or more stretch-normalized item-source metrics 130. For example, a response may include an ordered list of sources configured to provide one or more requested items, where the order is based on corresponding source scores 132. As another example, a response may identify—for each requested item—one or more sources configured to provide the item and the source score 132 and/or stretch-normalized item-source metric 130 for the source. As yet another example, a response may identify one or more combinations of sources that may collectively be configured to provide the requested items and a combination score associated with each combination (perhaps in addition to individual source scores associated with sources in the combination and/or stretch-normalized item-source metrics associated with the proposed combination).

In one exemplary instance, the computing system 110 can populate the response to the query 115 with the identified sources 124, the stretch-normalized item-source metrics 130 for the identified sources 124, and the like. In some embodiments, the computing system 110 can order the stretch-normalized item-source metrics 130 and the corresponding identified sources of the identified sources 124 in the response to the query 115 by the stretch-normalized item-source metrics 130. For example, the computing system 110 can generate the response to the query 115 such that a particular stretch-normalized item-source metric of the stretch-normalized item-source metrics 130 that has a highest likelihood of provisioning or procuring the requested items is listed above, larger than, or otherwise more prominently than other stretch-normalized item-source metrics of the stretch-normalized item-source metrics 130. Additionally or alternatively, the computing system 110 can transmit the response to the query 115 to the requestor 102, for example via a user interface, an output file, etc.

### Example of a Process for Determining a Source Metric Using Artificial Intelligence

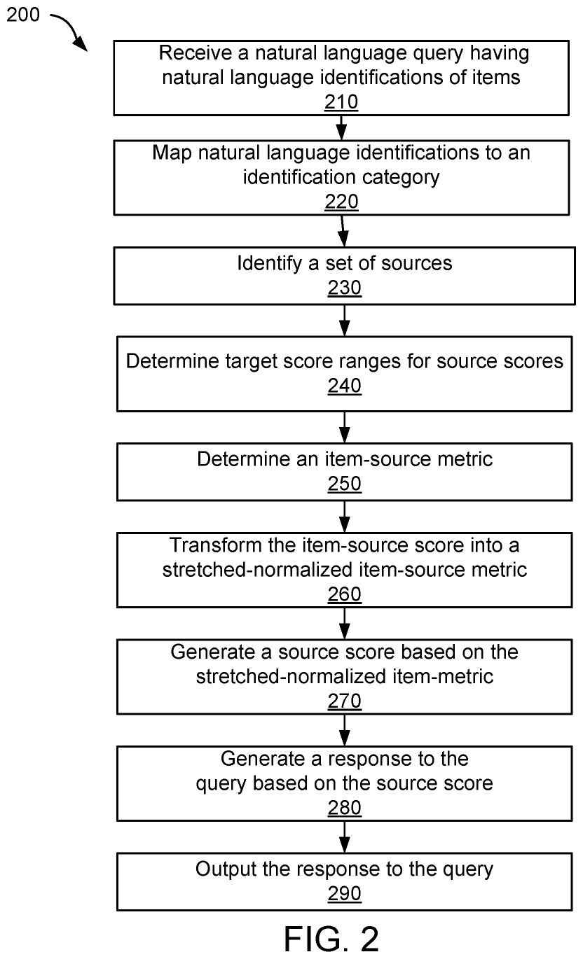

FIG. 2 is a flowchart of a process 200 for using an artificial intelligence technique for determining a source metric based on stretched normalization according to an embodiment. The process 200 may be performed at least in part by any of the components described in the figures herein, for example, by any component of the computing environment 100 or by the computing environment 100, itself. The process 200 begins at block 210, when the computing system 110 receives a query, such as the query 104, that includes natural language indications of items. The query can be generated and transmitted to the computing system 110 by a requesting entity, such as the requestor 102, which may be interested in receiving a response indicating sources that can provide the items. The natural language indications, such as the item indications 106, can include natural language phrases, words, strings, or the like that can indicate items in a natural language such as English, Spanish, German, etc. Additionally or alternatively, the query 104 can include an indication of a relative priority of a source characteristic for evaluating a set of sources that may be configured to provide one or more items. The source characteristic may involve how closely an item provided by the respective source is to a requested item, a time to receive an item provided by the respective source, an amount of resources used to provision an item provided by the respective source, etc.

At block 220, the computing system 110 maps the natural language indications to an identification category of one or more items indicated by the natural language indications. In some embodiments, the computing system 110 can include or can otherwise execute an artificial intelligence model, such as the artificial intelligence model 120, to map the natural language indications to the identification category of one or more items indicated by the natural language indications. For example, the computing system 110 can input the natural language indications into the artificial intelligence model, which may be or include a natural language processing model, and the artificial intelligence model can output one or more item-category mappings, such as the item-category mappings 122, that can relate the indications of items to corresponding categories of the indicated items. In a particular example, the computing system 110 can input a particular indication of a computer monitor into the artificial intelligence model, and the artificial intelligence model can output an item-category mapping that associates the indication with a category such as “computer hardware.”

At block 230, the computing system 110 identifies a set of sources. The computing system 110, or any component or subset thereof, can identify a set of sources such as the identified sources 124. The set of sources can be or include one or more sources configured to provide one or more items indicated by the item indications of the query and/or the item-category mappings. In some embodiments, the computing system 110 can query a database, a webpage, or the like to identify the set of sources. In a particular example, the computing system 110 may access the Internet and submit a query, for example to a search engine, to identify one or more sources of the set of sources that can provide one or more of the items. In another embodiment, the computing system 110 may access or query a database that includes indications of one or more sources that may be configured to provide one or more items associated with the item indications and/or the item-category mappings. Additionally, each source of the set of sources may be configured to, for at least one item of the set of items, provide an item that corresponds to an item category mapped to the item and included in the item-category mappings. In some embodiments, a quantity of items included in the set of items that a first source of the set of sources is configured to provide can be different than a quantity of items included in the set of items that a second source of the set of sources is configured to provide.

At block 240, the computing system 110 determines target score ranges for source scores. In some embodiments, the computing system 110, or any component or subset thereof, can determine target ranges, such as target ranges 126, for the source scores for the identified sources. The target ranges may correspond to source scores for the set of sources. For example, each source of the set of sources may have a corresponding source score that can indicate a likelihood of providing an item subject to certain parameters such as client-specified parameters, third-party-determined parameters, the source characteristics, and the like. The computing system 110 can determine each target range of the one or more target ranges in a corresponding target-range minimum to a corresponding target-range maximum. For example, and for a particular source of the set of sources, the computing system 110 can determine a target-range minimum source score and can determine a target-range maximum source score. The target-range minimum source score and the target-range maximum source score can be the minimum possible score and the maximum possible score for the corresponding source. In other examples, the target-range minimum source score and the target-range maximum source score can be the minimum acceptable score and/or the maximum acceptable score for the source, for example based on parameters specified by the query received by the computing system 110.

At block 250, the computing system 110 determines an item-source metric. The computing system 110 can use the item indications, the item-category mappings, and/or the set of sources to determine item-source metrics for each source of the set of sources. For example, and for each source of the identified sources, the computing system 110 can generate an item-source metric that can predict a degree to which a predicted provision of the corresponding item by the corresponding source accords with requestor priorities of a provision of the corresponding item. The requestor priorities may be included in the query and may indicate or include target item-provision parameters for provisioning the corresponding item. In a particular example, the target item-provision parameters may include an amount of resources to provision the corresponding item, a time to provision the corresponding item, a match percentage (e.g., to a requested item) of the corresponding item to be provisioned, and the like, or any combination thereof. The item-source metrics may each be within a metric range (e.g., predefined or observed for the item), which may be similar or identical to the corresponding target range of the target ranges, though the metric range may, in other examples, be different than the corresponding target range.

In some embodiments, the degree to which the predicted provision of the item by the source accords with the requestor priorities of the provision of the item can be based on a separate degree to which the item that the source is configured to provide is the same as the item identified in the set of items. For example, the item-source metric may be higher for a source configured to provide an exact match of a requested item compared with an item-source metric for a source configured to provide an item similar to the requested item. Additionally or alternatively, the degree to which the predicted provision of the item by the source accords with the requestor priorities of the provision of the item can be based on a predicted probability of the item being available for the source to transport. For example, the item-source metric may be higher for a source that is more likely to have or offer the requested item available compared with a score for a source that is less likely or unlikely to have or offer the requested item. In some embodiments, the predicted probability can be based on empirical indications as to whether or with what delay another item of a same type was received from the source by another requester. Additionally or alternatively, the degree to which the predicted provision of the item by the source accords with the requestor priorities of the provision of the item can be determined by generating, using a machine-learning model, a predicted requestor rating of provision of the item by the source. The machine-learning model can be or include the artificial intelligence model 120 or any other suitable machine-learning model configured to output the predicted requestor rating using item indications, the set of sources, and the like as input.

At block 260, the computing system 110 transforms the item-source metric into a stretch-normalized item-source metric. The computing system 110 may generate the stretched-normalization item-source metric by determining a product between the item-source metric and a stretched-normalization factor, which may be based on a ratio of a size of a target range of the target ranges relative to a maximum item-source metric among the item-source metrics. In some embodiments, the transformation of the item-source metric to the stretch-normalized item-source metric may not use a minimum of the item-source metrics across the set of sources. The stretched-normalization factor may be based on other suitable factors for stretch-normalizing the item-source metrics to generate the stretched-normalization item-source metrics. Additionally or alternatively, for each source of the set of sources, and for each item indicated by the query but not configured to be provided by the corresponding source, the computing system 110 can assign a default value as the corresponding stretch-normalized item-source metric. In some embodiments, the default value can be a predefined constant or can be based on the stretch-normalized item-source metrics associated with one or more other sources of the set of sources and associated with the item.

At block 270, the computing system 110 generates a source score based on the stretch-normalized item-source metrics. The computing system 110 can, for each source of the set of sources, generate the source score using the corresponding stretched-normalization item-source metric. The source score can indicate a likelihood of the respective source providing one or more requested items consistent with the requestor priorities or other parameters relating to provisioning or procuring the one or more requested items. In some embodiments, and for each source of the set of sources, the source score generated for the source can be selectively based on the at least one item of the set of items that the source is configured to provide.

At block 280, the computing system 110 generates a response to the query, such as the response to the query 115, using the source score. For example, the computing system 110 can populate the response to the query with identifications the set of sources, the source scores for corresponding sources, and the like. In some embodiments, the computing system 110 can order the source scores and the corresponding sources in the response to the query by the source scores. For example, the computing system 110 can generate the response to the query such that a particular source score that has a highest likelihood of provisioning or procuring the requested items is listed above, larger than, or otherwise more prominently than other source scores.

In some embodiments, the computing system 110 can rank the set of sources in the response to the query. For example, the computing system 110 can rank the set of sources based on corresponding source scores such that the response includes an identification of the set of sources and the ranking of the set of sources. Additionally or alternatively, the computing system 110 can determine an incomplete subset of the set of sources. The response to the query can include an identification of the incomplete subset of the set of sources. And, the response to the query can indicate which items of the set of items that the first source is configured to provide and which items of the set of items that the second source is configured to provide.

At block 290, the computing system 110 outputs the response to the query. In some embodiments, the computing system 110 can transmit the response to the query to a computing device used to submit the query to the computing system 110. In a particular example, the computing system 110 can transmit the response to the query to the requestor 102, for example via a user interface, an output file, etc.

The user interface may include one or more interactive elements that can be used to adjust the output provided by the computing system 110. For example, the user interface can include at least one field configured to receive input, for example from a requesting entity, indicating source characteristics prioritized by the requesting entity. In a particular example, the user interface can include a field configured to receive natural language input indicating the source characteristics, and the computing system 110 can input the natural language received via the field into the artificial intelligence model to infer the source characteristics.

### Example of a Data Flow for Determining a Source Metric Using Artificial Intelligence

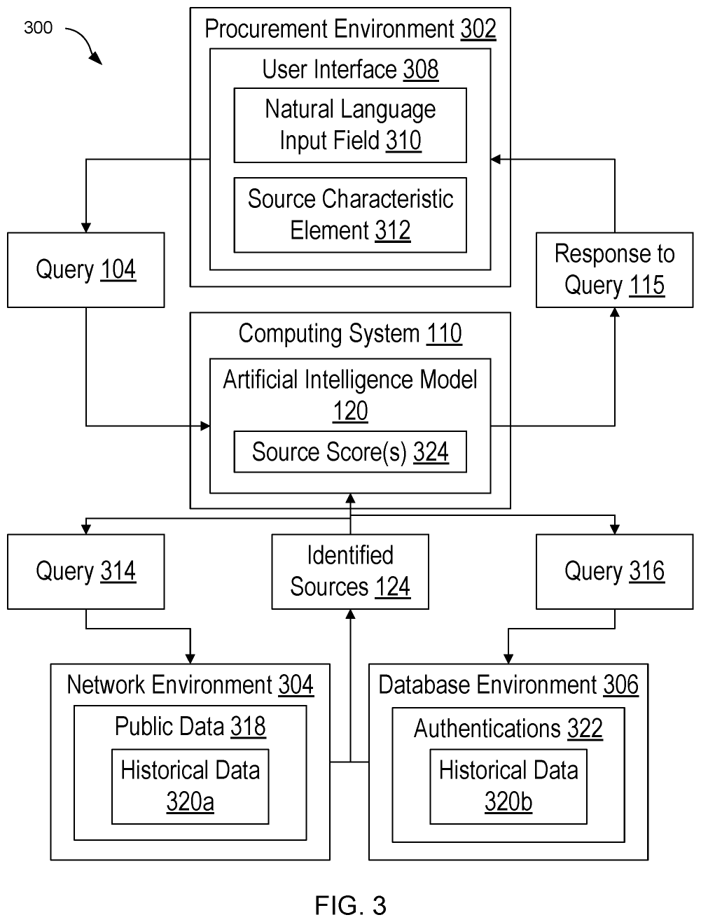

FIG. 3 is an example of a data flow diagram 300 for using an artificial intelligence technique for determining a source score based on stretched normalization according to an embodiment. The data flow diagram 300 can include or otherwise involve multiple environments, systems, and the like. For example, and as illustrated, the data flow diagram 300 can include a procurement environment 302, the computing system 110, a network environment 304, and a database environment 306, though any other environment or system can be used or involved with respect to the data flow diagram 300.

In some embodiments, the procurement environment 302 may be or include a computing environment provided by a requestor device such as a server farm, a server computer, a personal computing device, a mobile computing device, etc. The procurement environment 302 may be generated by the computing system 110 and transmitted to the requestor device to be displayed via user interface 308. The user interface 308 may include a natural language input field 310 among one or more other fields, interactive elements, read-only features, and the like. In a particular example, the natural language input field 310 may allow a requesting entity, which may be a requestor entity using the procurement environment 302, to input indications of a set of items to be procured. The indications may include natural language indications of the set of items. In a particular example, the input indications may include natural language phrases, words, letters, numbers, strings, and the like. Additionally, the user interface 308 may include a source characteristic element 312 that can allow the requesting entity to input indications of desired source characteristics for sources to be chosen to provide the requested items. In some embodiments, the source characteristic element 312 may be or include a list of potential source characteristics that can be ranked or otherwise ordered by the requesting entity by interacting with the source characteristic element 312. In other embodiments, the source characteristic element 312 may be or include a natural language field configured to receive natural language input indicating source characteristics, priorities thereof, or the like. Additionally or alternatively, the user interface 308 can include other fields, features, elements, and the like that can indicate authentication credentials of the requesting entity, authentication permissions of the requesting entity, and the like.

In a particular example, the requesting entity can include an individual attempting to procure computer monitors, cloud computing resources, wooden desks, and software licenses. The requesting entity can access the procurement environment 302 and can interact with the user interface 308. The requesting entity can input natural language indications of the computer monitors, the cloud computing resources, the wooden desks, and the software licenses into the natural language input field 310. Additionally, the requesting entity can interact with the source characteristic element 312 to indicate that the requesting entity mostly prioritizes near-exact matches for the requested items, that the requesting entity somewhat prioritizes a short lead-time for the requested items, and that the requesting entity does not prioritize a size of a source entity for providing the requested items. In some embodiments, the requesting entity can additionally provide authentication credentials, authentication permissions, and the like. For example, the user interface 308 may be configured to receive authentication credentials that may indicate a level of access, types of data, and the like that can be accessed on behalf of the requesting entity. Additionally, the user interface 308 may be configured to receive authentication permissions that may indicate a level of access, types of data, and the like requested by the requesting entity to be accessed for procuring the items.

The procurement environment 302 can be used to generate and submit a query 104. For example, in response to receiving natural language input, the source characteristics, the authentication information, and the like via the user interface 308, the procurement environment 302, or any computing device, etc. thereof, can generate the query 104 that includes indications of the requested items, indications of the source characteristics, indications of the authentication information, and the like. The procurement environment 302 can transmit the query 104 to the computing system 110 to request recommendations for procuring the requested items.

The computing system 110 can receive the query 104 and can parse the query 104 to access the indications of the requested items, the indications of the source characteristics, the indications of the authentication information, and the like. The computing system 110 can include, access, or otherwise execute the artificial intelligence model 120 using the indications of the requested items, the indications of the source characteristics, the indications of the authentication information, and the like. For example, in response to parsing the query 104, the computing system 110 can input indications of the requested items, of the source characteristics, and/or of the authentication information, and the like into artificial intelligence model 120. Artificial intelligence model 120 may generate item-category mappings, item-source metrics, stretched-normalization item-source metrics, other values, or any combination thereof.

In a particular example, the computing system 110 can input the indications of the requested items into the artificial intelligence model 120 to map the input indications to categories representing the input indications. In some embodiments, the artificial intelligence model 120 can include or otherwise involve a nearest neighbor model, a generative model, a Transformer model, and the like. Additionally or alternatively, the artificial intelligence model 120 can include or involve one or more parallel models such as parallel nearest neighbor models, parallel generative models, parallel Transformer models, etc.

In some embodiments, the computing system 110 can be communicatively coupled with the network environment 304 and/or the database environment 306. For example, the computing system 110 can generate and submit a query 314 to, or otherwise access, the network environment 304, a query 316 to, or otherwise access, the database environment 306, or a combination thereof. The network environment 304 can include the Internet or other network that can access or include public data 318 and/or non-public data. The public data 318 may be or include historical data 320a that can be used by the computing system 110, or any component or model thereof, to identify one or more sources that may be configured to provide one or more of the requested items. For example, historical data 320a may include current or former webpage impressions, current or former item offerings from potential sources or identified sources, and the like. In some embodiments, the query 314 can cause the historical data 320a to be identified and can cause at least a portion of the identified sources 124 to be generated and/or identified, for example based at least on the historical data 320a.

Additionally, the computing system 110 can query (e.g., by transmitting the query 316) or otherwise access the database environment 306. The database environment 306 may be or include data storage devices such as computer memory of personal computing devices, computer memory of server computers, computer memory of cloud computing resources, and the like. The computing system 110 can generate and submit the query 316 to, or otherwise communicate with the database environment 306 to, access the database environment 306, which may include authentications 322 and other stored data. The authentications 322 may be or include stored indications of authentication accesses, authentication permissions, and the like for various requesting entities, or other entities that may use the computing system 110 or any service provided via the computing system 110. In a particular example, the authentications 322 can include an authentication permission provided by the requesting entity using the procurement environment 302, an authentication access level associated with the requesting entity using the procurement environment 302, and the like. The authentication permission may indicate a level of access to data associated with the requesting entity that the computing system 110 may use with respect to requests from other entities. Additionally, the authentication access level may indicate which data or level of data access that the computing system 110 can use to fulfill the request submitted via the query 104 or otherwise transmitted to the computing system 110 via the procurement environment 302. The computing system 110 can use the authentications 322 to search or otherwise query computer memory included in the database environment 306 to identify or otherwise select one or more sources to contribute to the identified sources 124. For example, the computing system 110 can use a nearest neighbor algorithm (e.g., the parallelized nearest neighbor algorithm described above) to identify one or more sources of the identified sources 124 based on input item indications and/or source characteristics included in the query 104.

The computing system 110 can receive the identified sources 124 based on the query 314 and/or the query 316, or otherwise based on accessing the network environment 304 and/or the database environment 306, and the computing system 110 can generate source score(s) 324 based on the identified sources 124. The computing system 110 can use the identified sources 124, along with the item-category mappings, the item indications, and the like, to generate the source score(s) 324. In some embodiments, the computing system 110 can use the artificial intelligence model 120 to generate the source score(s) 324 or any intermediate step to generate the source score(s) 324. In a particular example, the computing system 110 can use the artificial intelligence model 120 to generate the item-category mappings based at least on the item indications included in the query 104, to generate the item-source metrics using the item indications, the item-category mappings, and the identified sources 124. Each of one or more item-source metric can be transformed into a stretch-normalized item-source metric. Then, for each source, a source score 324 can be generated based on the stretch-normalized item-source metrics associated with the source and the items being requested.

Given that a particular query can relate to multiple items, a metric to be associated with a particular source may be based on metrics that are associated with each of one or more items being requested and the source (i.e., an item-source metric, normalized version of an item-source metric, or stretch-normalized version of an item-source metric).

In some examples, outputs determined by the artificial intelligence model 120 can be merged or otherwise aggregated during at a negotiation level. The negotiation level may involve considering all items indicated by the item indications as compared to item level, which may involve consider a particular item or line item indicated by the item indications. In some embodiments, the computing system 110 can use the artificial intelligence model 120, or any other computer model, computer algorithm, or computer-based technique, to determine the source score(s) 324 using a stretch-normalization item-source metric and/or a standard normalization item-source metric for each of one or more items. One possible example of an equation that the computing system 110 can use to determine a stretch-normalization item-source metric

$${A}_{i} = {R}_{min} + ( {S}_{i} - {S}_{min} ) * ( \frac{{R}_{max} - {R}_{min}}{{S}_{max} - {S}_{min}} ) \qquad ( Equation 1 )$$

In Equation 1, Aᵢ can represent the stretch-normalization item-source metric, Rₘᵢₙ can represent a minimum of a target range of stretch-normalization item-source metrics (e.g., across sources), Rₘₐₓ can represent a maximum of the target range, Sᵢ can represent a particular unnormalized item-source metric (e.g., corresponding to a given source and/or instance), Sₘᵢₙ can represent the minimum unnormalized item-source metric (e.g., across sources) for a particular item, and Sₘₐₓ can represent the maximum unnormalized item-source metric (e.g., across sources) for the particular item. The stretch-normalization calculation is contrasted with an exemplary calculation of a standard-normalization metric:

$${A}_{i} = {R}_{min} + {S}_{i} * ( \frac{{R}_{max} - {R}_{min}}{{S}_{max}} ) \qquad ( Equation 2 )$$

Notably, the exemplary calculation (in Equation 2) for computing the standard-normalization metric does not use Sₘᵢₙ, which may potentially be negligible but may be not exactly zero, and the range of stretch-normalized item-source metrics may range from a minimum value, which may not be zero, to a maximum value such as 100, 200, 300, 400, or any other suitable value.

One approach for generating a source score is to: (1) for each requested item that a given source is predicted or known to provide, assign a stretch-normalization item-source metric for the item-source pair; (2) at least for each requested item that a given source is predicted or known to provide (and potentially for all requested items), assign a weighting for the item (e.g., based on prioritization of one or more factors, as identified by a requesting entity); and (3) generate a source score 324 based on the stretch-normalization item-source metrics and the weightings.

For example, the source score 324 corresponding to a source may be or may be based on a statistic (e.g., a weighted or unweighted: mean, median, mode, percentage above a threshold, etc.) generated based on the stretch-normalization item-source metrics associated with both the source and with the requested items and/or stretch-normalization item-source metrics associated with all items availed by the source. In some instances, if a given source is not configured to provide one or more requested items, a default value (e.g., 0 or a non-zero value) is used in lieu of a stretch-normalization item-source metric for the given item when generating the statistic. In some instances, if a given source is not configured to provide one or more requested items, the statistic is generated using only the stretch-normalized item-source metrics associated with items for which the source is configured to provide.

The weightings applied may be based on (e.g., defined by, correlated to, etc.) a user-identified relative importance (e.g., in terms of a ranking or importance numeric/categorical identifiers), cross-source item-cost statistics (e.g., to identify higher weights to items associated with higher average/median/etc. costs), etc.

This approach for generating source scores can therefore provide an approach that indicates, at the negotiation stage, a relative importance of source characteristics and/or various specific items being requested. Additionally, the final, normalized score can be bound by a target range, which may be bound by a target minimum score and/or a target maximum score, which can thus support an intuitive meaning for providing the source score(s) 324 derived based on the stretch-normalized item-source metrics to the requesting entity via the user interface 308 as a recommendation score.

The computing system 110 can generate a response to the query 115 using the source scores(s) 324. For example, the computing system 110 can generate an update to the user interface 308, an interactive element of the user interface 308, and the like using the source score(s) 324. In some embodiments, the response to the query 115 can include ranked or otherwise ordered values. For example, the response to the query 115 can include at least a list of the identified sources 124 ranked by accordance with the source characteristics and/or the item indications included in the query 104. The computing system 110 can rank the identified sources 124 using the source metric(s) 132. For example, sources of the identified sources 124 that have higher source scores may be presented first, more prominently than other sources, larger than other sources, and the like. The response to the query 115 can be transmitted to the procurement environment 302, for example to be displayed on the user interface 308, to update the user interface 308, etc.

In a particular example, the response to the query 115 can include a ranked list of the identified sources 124. The identified sources 124 may include 15 sources that are each configured to provide at least one item indicated by the query 104. The ranked list of the response to the query 115 can have a first source that best accords with the item indications and/or source characteristics of the query 104 listed first, most prominently, etc. The ranked list of the response to the query 115 can have remaining sources of the identified sources 124 listed in descending order of accordance with the item indications and/or source characteristics of the query 104. Additionally or alternatively, the response to the query 115 may exclude at least a portion of the identified sources 124. For example, the computing system 110 may exclude sources that are not configured to provide one or more items indicated by the item indications, that accord with the item indications and/or the source characteristics less than a threshold amount, and the like. In a particular example, the response to the query 115 may include a ranked list of five of the 15 sources such that 10 of the 15 sources may be excluded as not being configured to provide an item or not according with the item indications and/or the source characteristics.

The response to the query 115 can be transmitted to the procurement environment 302 and can be provided, for example to the requesting entity, via the user interface 308. The user interface 308 may be configured to provide the response to the query 115 and/or may be configured to facilitate adjustments to the response to the query 115, etc. Adjustments to the response to the query 115 may involve adjusting an algorithm, a computer model, the artificial intelligence model 120, or inputs thereto for generating a different response to the query 115. For example, the user interface 308 may provide an input field via the procurement environment 302 that may be configured to receive input for adjusting the response to the query 115. The input field may be or include a natural language input field, a field including one or more interactive features that can be selected by the requesting entity, or the like. The user interface 308 can receive input via the input field and can transmit the input to the computing system 110.

The computing system 110 can parse the input or may otherwise infer from the input one or more changes to be made to the source score(s) 324 or any techniques used to determine the source score(s) 324. For example, the computing system 110 can determine that the input indicates one or more changes to the source characteristics or priorities emphasized by the requesting entity. In a particular example, the input may indicate that the requesting entity prioritizes a large source that can provide each of the items indicated by the query 104. In this example, the computing system 110 can adjust the artificial intelligence model 120, or other models like the nearest neighbor model, etc., to adjust the source score(s) 324 previously generated by the computing system 110. The adjustments to the artificial intelligence model 120, or any other model of the computing system 110, may involve updating the source characteristics, updating the item-category mappings, updating the identified sources, updating the item-source metrics, updating the stretch-normalized item-source metrics, updating techniques performed by the artificial intelligence model 120 and/or the other computer models, or any combination thereof to generate updated source score(s). The computing system 110 can generate an updated response to the query based on the updated source metric(s), based on an updated presentation of the source score(s) 324 and/or the updated source score(s), or a combination thereof, and the computing system 110 can transmit the updated response to the query to the procurement environment 302 for providing the updated response to the query to the requesting entity.

### Example of User Interfaces for Receiving and Processing Queries Using Source Metrics

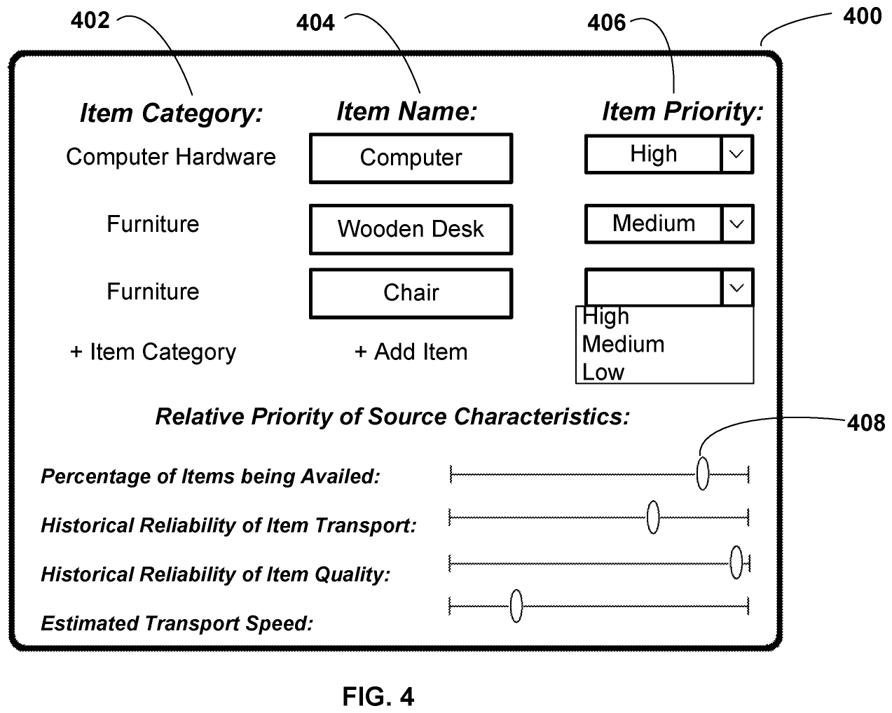

FIG. 4 is an exemplary user interface 400 configured to receive identification of items being requested and various prioritizations, in accordance with various embodiments of the present invention. As shown in the figure, the user interface 400 includes one or more input fields and/or interactive elements, configured to receive a user input indicating a query. The query can include a request for information about procuring, or otherwise acquiring, one or more items, such as computing hardware, computing resources, manufactured goods, services, and the like.

In some instances, the user interface 400 includes at least one input field 402, among one or more other fields, that relate to the user input associated with an item category. The item category may include a categorization and/or classification of a type of item requested by the requesting entity. For example, the item category depicts one or more input fields that relate to at least one of computer hardware (402a), furniture (402b), software, air conditioning systems, stationery, and the like (402n) corresponding to the one or more items requested by the requesting entity.

In some instances, the user interface 400 includes at least one item-identification input field 404, among one or more other fields, that relates to the user input associated with an item name. The item name relates to a specific item, which the requesting entity is interested in procuring, or otherwise acquiring, using the user interface 400. For example, the requesting entity may request to procure, or otherwise acquire a computer (404a), a wooden desk (404b), a chair (403b), computer monitors, cloud computing resources, pens, notepads, and the like (404n). Thus, it will be appreciated that the user may use the user interface 400 to indicate an interest in procuring multiple items.

In some instances, the user interface 400 includes at least one item-prioritization input field 406, among one or more other fields, that is configured to user input that identifies a priority of an item identified in a corresponding input field 404. Thus, the item-prioritization item field 406 may be used to receive input that indicates, for each item of the one or more items, a relative priority for the item for which the requesting entity may request to procure, or otherwise acquire. For instance, the item priority may relate to the degree of importance of each item of the one or more items, to the requesting entity. As shown but not limited to, the at least one input field indicates that the computer corresponding to the computer hardware category is associated with a high priority field (406a). Similarly, an item-prioritization input field indicates that the wooden desk corresponds to the furniture prioritization may be identified via input that is (for example) numeric instead of categorical.

Additionally, the user interface 400 includes a source-characteristic-prioritization input field 408, among one or more other fields, to receive the user input that indicates a user-identified relative priority of each of one or more source characteristics.

Exemplary source characteristics can relate to a percentage of the one or more items being availed by a given source, a historical reliability of transportation associated with the source, a historical reliability of quality associated with the source, an estimated speed of the transportation provided by (e.g., in terms of a future prediction or historical statistic) the source, a price of the item as being availed by the source, and the like. The source-characteristic-prioritization input field 408 can be rendered to present at least one slider corresponding to each of the source characteristics, which can be configured to receive the user input that identifies a relative priority of a source characteristic relative to the priorities of other source characteristics. In some instances, a position of the slider indicates a source-prioritization weighting metric within a predefined scale, such as a scale ranging from a scale of 0 to 10 (e.g., with 0 indicating that a given source characteristic is unimportant and 10 indicating that the source characteristic is of maximum importance). Additionally, or alternatively, the source-characteristic-prioritization input field 408 may render a provision to manually enter a numeric source-prioritization weighting metric, select from multiple source-prioritization weighting metrics (e.g., which may be numeric or categorical), etc.

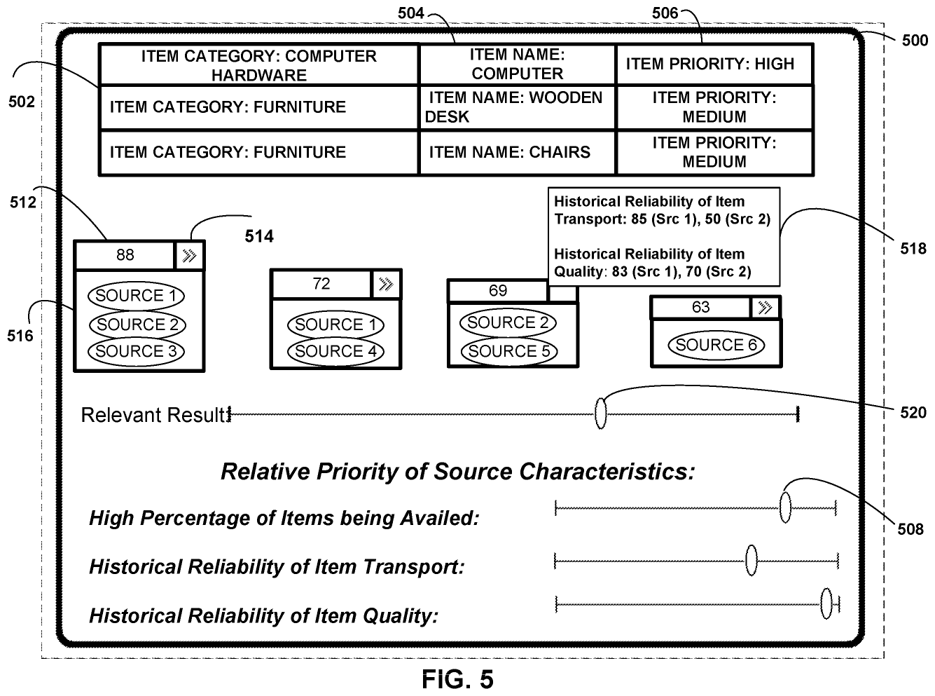

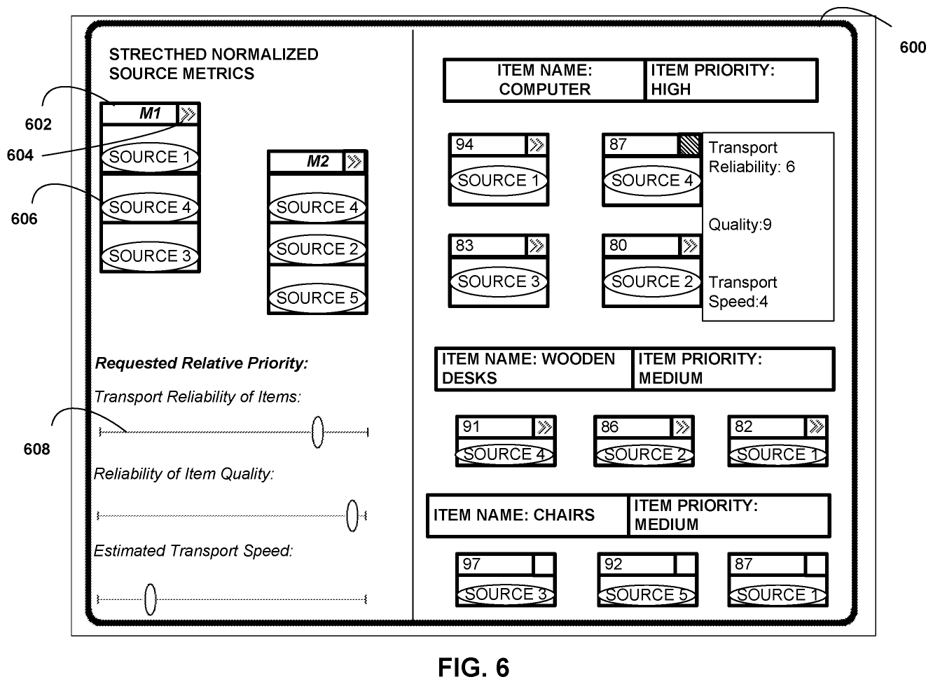

Advantageously, the user interface 400 relates to an interactive and an easy-to-use user interface that is configured to receive the query indicating the item category (402) corresponding to the requested item under the item names (406) and further corresponding to the degree of importance of each of the requested item. The additional parameters associated with the relative priority of the source characteristics facilitate a thorough evaluation of a set of sources that can be included in a response (e.g., as shown in FIGS. 5 and 6) for the requesting entity. Either and/or both of the item prioritization and/or the source-characteristic prioritization can be used in a process that implements a stretched-normalization technique disclosed herein so as to customize a response to a multi-item query.

FIG. 5 is an exemplary user interface 500 configured to present preliminary source data corresponding to a request for a set of items and to receive prioritization-modifications to trigger source-identification updates in accordance with an embodiment. As shown in the figure, the user interface 500 includes one or more input fields and/or interactive elements, configured to present a response to a query (e.g., the exemplary query represented in FIG. 4) that relates to procuring, or otherwise acquiring one or more items, such as computing hardware, computing resources, manufactured goods, services, and the like. The response may indicate one or more source scores and/or one or more combined scores, each of which may be based on one or more stretched-normalization item-source metrics (e.g., as determined in accordance with a disclosure presented herein and/or as determined using Equation 1).

As further shown in the figure, the user interface 500 depicts fields 502, 504, 506, and 508 that correspond to the input fields 402, 404, 406, and 408 of FIG. 4, as described above. In some instances, the field 502 depicts a category element corresponding to the user input associated with an item category. In some instances, the field 504 depicts the input field corresponding to the user input associated with an item name. In some instances, the field 506 depicts the input field corresponding to the user input associated with an item priority. In some instances, the field 508 depicts the input fields corresponding to the user input associated with a relative priority of a source characteristic, respectively.

Additionally, the user interface 500 is configured to include various combination scores 512, each of which is generated based on one or more source scores corresponding to one or more sources that are identified as providing some or all of the items that had been requested. For example, if a single source is configured to provide all of the requested items, the combination score 512 could be equal to the source score associated with the single source.

If each of a set of sources is configured to provide or preliminarily identified for providing different (e.g., non-overlapping) subsets of the requested items, a combination score 512 may be defined to be a weighted average (or other statistic) based on the source scores of the set of sources. The weights may be determined based on (for example) a number of items in respective subsets of requested items, user-identified absolute or relative priorities of items, etc.

In some instances, a combination score 512 is configured to be associated with an expandable option 514 (e.g., an expansion arrow) that, when selected, presents one or more source-identification elements 516 that identify one or more particular sources that have been preliminarily selected for potentially providing (or collectively providing) the items that were identified in a query. In the illustrated representation, the expandable field 514 is configured to be located adjacent to the combination score 512, depicting the score and/or the value associated with the stretched normalized source metric. However, the expandable field 514 may be located and/or placed at any other suitable location on the user interface 500 (e.g., such that it facilitates expansion of a window 518). Further, the exemplary user interface 500 is configured to include a field 520 to adjust a number of relevant results depicting the at least one source and/or the set of sources that can provide one or more, or all, of the items requested by the requesting entity. For example, as the slider is slid further to the left, more source combinations may be presented (e.g., with corresponding scores 512), though the scores 512 of the newly added source combinations may be lower than those previously presented.

In some instances, the source-identification element 516 is used to facilitate presenting a response to the query based on the user input related to prioritization of source characteristics. For each preliminary identification of a single source or set of sources that are configured to provide the requested items, a combined score may be generated using one or more source scores and/or one or more item weightings. For example, a combined score may be defined by generating a weighted average of all stretch-normalized item-source metrics corresponding to the pairs of items and sources in the preliminary identification. As another example, a combination score may be defined by weighting each stretched-normalization item-source metric corresponding to each item-source pair in the preliminary identification by a source score of the corresponding source (e.g., that may have been generated based on data corresponding to all items availed by the source—not just those being requested) and then defining the combination score 512 to be a statistic of the weighted stretched-normalization item-source metrics (e.g., where the statistic is an average). Each stretched-normalization item-source metric may be determined in accordance with a normalization equation disclosed herein, such as in Equation 1.

For example, a first source-identification element is configured to present a first set of sources including source 1, source 2, and source 3, based on the score and/or the value associated with the stretched normalized source metric. In the depicted instance, the first set of sources is associated with the highest combined score (e.g., based on one or more stretched normalized source metrics corresponding to various item-source pairs) relative to other sets of sources.

The source score for any one source or set of sources being considered for item provision may be generated using a technique disclosed herein and/or by: (1) generating an initial item-source metric for each item-source combination that corresponds to each and all items being requested; (2) generating a stretch-normalized item-source metric for each item-source combination using the initial item-source metric and a technique disclosed herein for performing a stretched normalization (e.g., corresponding to equation 1); and (3) generating a source score using the stretch-normalized item-source metrics and weightings that apply to various items (e.g., based on input received that indicates prioritizations of various items).

In some instances, the user interface 500 is configured to display identification of the at least one source and/or the identification of each of the set of sources in an ordered arrangement according to the score 512 associated with the stretched normalized source metric. For example, the ordered arrangement may include presentation and/or visual representation of the at least one source and/or the set of sources in accordance with a descending order of the score 512 associated with the stretched normalized source metric. In another example, the ordered arrangement may include presentation and/or visual representation of the at least one source and/or the set of sources in accordance with an ascending order of the score 512 associated with the stretched normalized source metric. In yet another example, the ordered arrangement may include presentation and/or visual representation of the at least one source and/or the set of sources in accordance with one of the descending or ascending order in conjunction with a movement and/or adjustment of a slider associated with the field 520.

Further, the interface t00 can include an expandable-field option 514 that, when selected, provides details regarding a scoring criterion to the requesting entity. The user interaction may include but is not limited to a single click on the expansion arrow, double click on the expansion arrow, hovering over the expansion arrow for a predetermined time limit, sliding the expansion arrow to right, or any other suitable input to facilitate display of the window 518.

In some instances, the user interface 500 is configured to display scoring information in the window 518 based on the user interaction. The scoring information may include source-specific information and/or collective information. Further or alternatively, the scoring information may include information that is at the item level, the request level, or the source level. For example, the scoring information as shown in FIG. 5 depicts source-level information that represents the reliability of item transport and the reliability of item quality, which can both be determined across all items availed by a source (even if one or more items do not pertain to a given request) or can be determined for one or more items associated with the request. The scoring information may further include, but is not limited to, details regarding which items are being associated with a given source, one or more item-source metrics, one or more item-source metrics transformed into stretch-normalized item-source metric(s), target ranges relative to a maximum item-source metric among a plurality of item-source metrics and the like.

Additionally, or alternatively, the scoring information may include an option to obtain one or more related stretch-normalized item-source metrics in accordance with a related average computational technique and/or a standard average computational technique. The requesting entity may choose to obtain the source metric information in accordance with the related average computational technique and/or the standard average computational technique based on a user interaction via the user interface 500.

Advantageously, the user interface 500 is configured to provide an intuitive visual representation of the response to the query that relates to procuring, or otherwise acquiring the one or more items. It will be appreciated that the descriptive information regarding the source metric(s), identification of sets of the sources in accordance with relative priority of source characteristics, ordered arrangement of the identified sets of sources, and the like facilitates an interactive user interface that aids the requesting entity to carry out the procurement process more efficiently.

FIG. 6 is an exemplary user interface configured to present preliminary source data corresponding to a request for a set of items and to receive prioritization-modifications to trigger source-identification updates according to an embodiment. As shown in the figure, the user interface 600 includes one or more input fields and/or interactive elements, configured to present a response to the query that relates to procuring, or otherwise acquiring one or more items, such as computing hardware, computing resources, manufactured goods, services, and the like. The response may indicate a source score based on stretched normalization according to the present invention, for one or more sources that can provide one or more, or all, of the items requested by a requesting entity.

The user interface 600 depicted in FIG. 6 is a modified version of the user interface 500 depicted in FIG. 5. In some instances, the user interface 600 is configured to depict the response by presenting different sets of one or more sources to the requesting entity. For example, the user interface 600 is configured to identify a score 602 and/or a value (M1) associated with a stretched normalized source metric, according to the present invention. In some instances, the field 602 is configured to be associated with an expandable field 604 depicted by an expansion arrow. In some instances, the user interface 600 is configured to include an identification of set of sources 606 that can provide one or more, or all, of the items requested by the requesting entity.

The score 602 is different than an analogous score 512 depicted in FIG. 5 in the sense that combined score 602 reflects the score and/or the value associated with the stretched normalized source metric based on a user interaction. For example, the combined score and/or the value associated with a stretched normalized source metric is reflected based on a selection of an option related to a related average computational technique and/or a standard average computational technique. The score and/or the value associated with the stretched normalized source metric is rendered in accordance with the selected option.

The expandable field 604 is configured to provide details regarding a scoring information to the requesting entity, based on a user interaction with the expansion arrow. In some instances, the user may be required to make an initial selection with regard to a scoring format based on the related average computational technique and/or the standard average computational technique. Once the initial selection is completed, the user interface 600 enables the user interaction in accordance with the expansion arrow. Additionally or alternatively, the user interface 600 enables user interaction in accordance with the expansion arrow once the initial selection is completed and a predetermined time window relative to the visual representation of the score and/or the value associated with a stretched normalized source is displayed, is elapsed.

Further, the user interface 600 is configured to provide an item-source metric and associated scoring information for each of the item-source set identified in response to the relative priority of source characteristics. For example, the user interface 600 is configured to indicate an item-source metric of 87 for an item indicating “computer” based at least on parameters such as transport reliability, quality, and transport speed as requested by the requesting entity in accordance with desired source characteristics.

Embodiments of the present invention disclose potential sources based on the item-source metric and priority of the source characteristics relative to the source and item priority. To further aid the requesting entity in decision-making associated with procurement of the one or more items, the user interface 600 is configured to provide different sets of one or more sources arranged in a visually intuitive manner. For example, the set of sources including source 1, source 4, and source 3 is presented at a position higher than a position of the set of sources including source 4, source 2, and source 5.

### Illustrative Systems

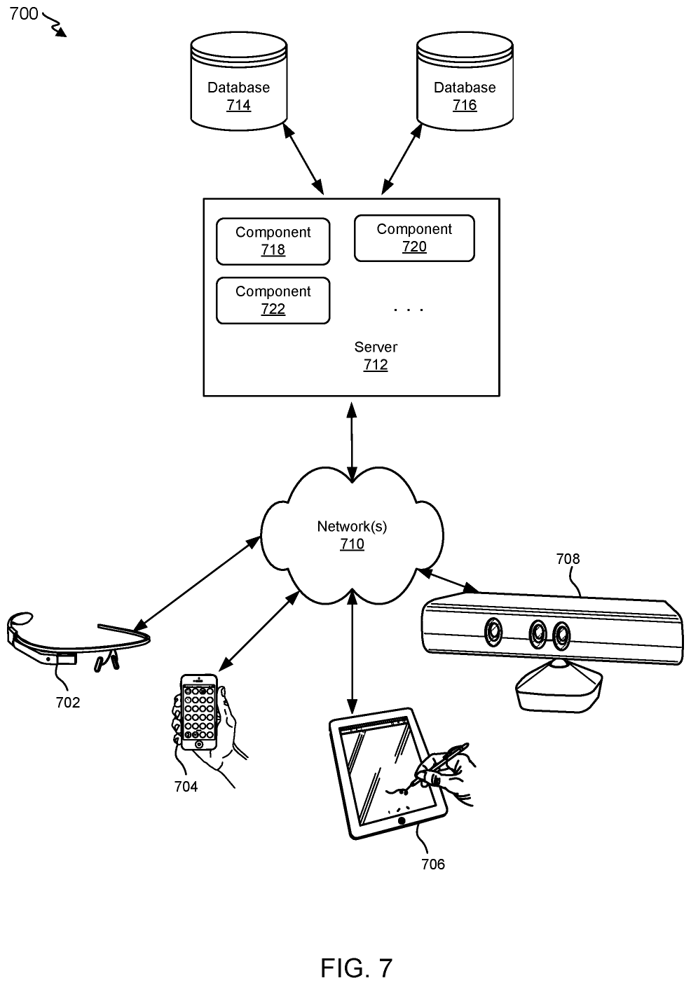

FIG. 7 depicts a simplified diagram of a distributed system 700 for implementing one of the embodiments. In the illustrated embodiment, distributed system 700 includes one or more client computing devices 702, 704, 706, and 708, which are configured to execute and operate a client application such as a web browser, proprietary client (e.g., Oracle Forms), or the like over one or more network(s) 710. Server 712 may be communicatively coupled with remote client computing devices 702, 704, 706, and 708 via network(s) 710.

In various embodiments, server 712 may be adapted to run one or more services or software applications provided by one or more of the components of the system. In some embodiments, these services may be offered as web-based or cloud services or under a Software as a Service (SaaS) model to the users of client computing devices 702, 704, 706, and/or 708. Users operating client computing devices 702, 704, 706, and/or 708 may in turn utilize one or more client applications to interact with server 712 to utilize the services provided by these components.

In the configuration depicted in the figure, the software components 718, 720 and 722 of distributed system 700 are shown as being implemented on server 712. In other embodiments, one or more of the components of distributed system 700 and/or the services provided by these components may also be implemented by one or more of the client computing devices 702, 704, 706, and/or 708. Users operating the client computing devices may then utilize one or more client applications to use the services provided by these components. These components may be implemented in hardware, firmware, software, or combinations thereof. It should be appreciated that various different system configurations are possible, which may be different from distributed system 700. The embodiment shown in the figure is thus one example of a distributed system for implementing an embodiment system and is not intended to be limiting.

Client computing devices 702, 704, 706, and/or 708 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. In some embodiments, the client computing devices can be special purpose computers that may be programmed or otherwise designed to perform a defined function via an embedded system, or the like, to perform the defined function independent of other tasks. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 702, 704, 706, and 708 may be any other electronic device, such as a thin-client computer, an Internet-enabled gaming system (e.g., a Microsoft Xbox gaming console with or without a Kinect® gesture input device), and/or a personal messaging device, capable of communicating over network(s) 710.

Although distributed system 700 is shown with four client computing devices, any number of client computing devices may be supported. Other devices, such as devices with sensors, etc., may interact with server 712.

Network(s) 710 in distributed system 700 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 710 can be a local area network (LAN), such as one based on Ethernet, Token-Ring and/or the like. Network(s) 710 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 712 may be composed of one or more general purpose computers, special purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 712 may be adapted to run one or more services or software applications described in the foregoing disclosure. For example, server 712 may correspond to a server for performing processing described above according to an embodiment of the present disclosure.

Server 712 may run an operating system including any of those discussed above, as well as any commercially available server operating system. Server 712 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Examples of database servers include without limitation those commercially available from Oracle, Microsoft, Sybase, IBM (International Business Machines), and the like.

In some implementations, server 712 may include one or more applications to analyze and consolidate data feeds and/or event updates received from users of client computing devices 702, 704, 706, and 708. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 712 may also include one or more applications to display the data feeds and/or real-time events via one or more display devices of client computing devices 702, 704, 706, and 708.

Distributed system 700 may also include one or more databases 714 and 716. Databases 714 and 716 may reside in a variety of locations. By way of example, one or more of databases 714 and 716 may reside on a non-transitory storage medium local to (and/or resident in) server 712. Alternatively, databases 714 and 716 may be remote from server 712 and in communication with server 712 via a network-based or dedicated connection. In one set of embodiments, databases 714 and 716 may reside in a storage-area network (SAN). Similarly, any necessary files for performing the functions attributed to server 712 may be stored locally on server 712 and/or remotely. In one set of embodiments, databases 714 and 716 may include relational databases, such as databases provided by Oracle, that are adapted to store, update, and retrieve data in response to SQL-formatted commands.

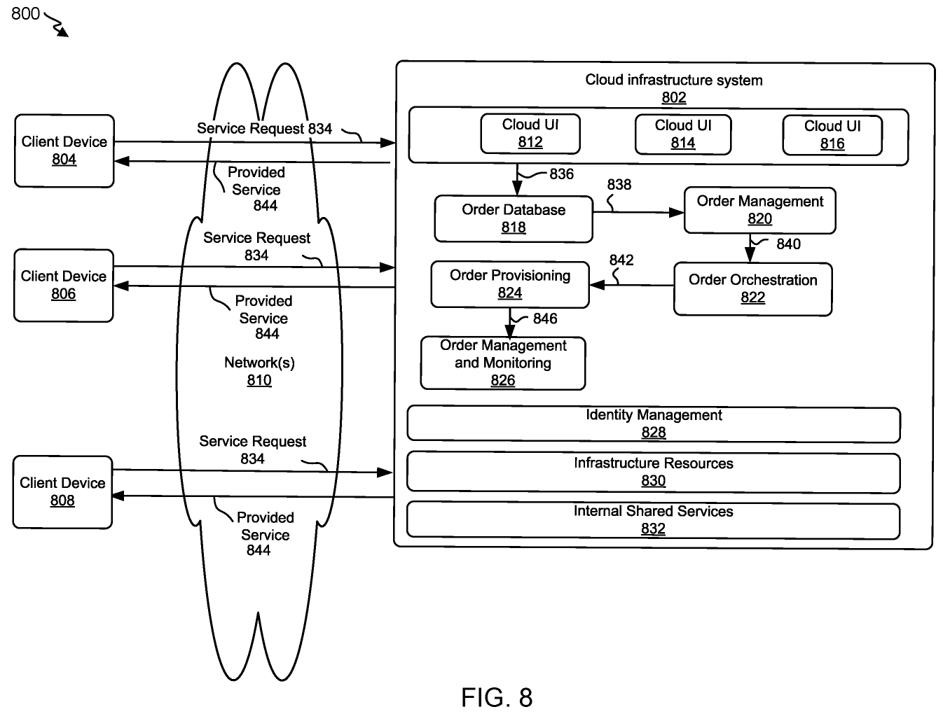

FIG. 8 is a simplified block diagram of one or more components of a system environment 800 by which services provided by one or more components of an embodiment system may be offered as cloud services, in accordance with an embodiment of the present disclosure. In the illustrated embodiment, system environment 800 includes one or more client computing devices 804, 806, and 808 that may be used by users to interact with a cloud infrastructure system 802 that provides cloud services. The client computing devices may be configured to operate a client application such as a web browser, a proprietary client application (e.g., Oracle Forms), or some other application, which may be used by a user of the client computing device to interact with cloud infrastructure system 802 to use services provided by cloud infrastructure system 802.

It should be appreciated that cloud infrastructure system 802 depicted in the figure may have other components than those depicted. Further, the embodiment shown in the figure is only one example of a cloud infrastructure system that may incorporate an embodiment of the invention. In some other embodiments, cloud infrastructure system 802 may have more or fewer components than shown in the figure, may combine two or more components, or may have a different configuration or arrangement of components.

Client computing devices 804, 806, and 808 may be devices similar to those described above for 702, 704, 706, and 708.

Although system environment 800 is shown with three client computing devices, any number of client computing devices may be supported. Other devices such as devices with sensors, etc. may interact with cloud infrastructure system 802.

Network(s) 810 may facilitate communications and exchange of data between clients 804, 806, and 808 and cloud infrastructure system 802. Each network may be any type of network familiar to those skilled in the art that can support data communications using any of a variety of commercially-available protocols, including those described above for network(s) 810.

Cloud infrastructure system 802 may comprise one or more computers and/or servers that may include those described above for server 712.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can be scaled based on the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 802 may include a suite of applications, middleware, and database service offerings that are delivered to a customer in a self-service, subscription-based, reliable, highly available, and secure manner. The database service offerings may involve computing/storage resources being provisioned and configured for specialized use as needed, and the resources being un-provisioned in scenarios where the resources are not needed or not expected to be needed within a timeframe. An example of such a cloud infrastructure system is the Oracle Public Cloud provided by the present assignee.

In various embodiments, cloud infrastructure system 802 may be adapted to automatically provision, manage and track a customer's subscription to services offered by cloud infrastructure system 802. Cloud infrastructure system 802 may provide the cloud services via different deployment models. For example, services may be provided under a public cloud model in which cloud infrastructure system 802 is owned by an organization selling cloud services (e.g., owned by Oracle) and the services are made available to the general public or different industry enterprises. As another example, services may be provided under a private cloud model in which cloud infrastructure system 802 is operated solely for a single organization and may provide services for one or more entities within the organization. The cloud services may also be provided under a community cloud model in which cloud infrastructure system 802 and the services provided by cloud infrastructure system 802 are shared by several organizations in a related community. The cloud services may also be provided under a hybrid cloud model, which is a combination of two or more different models.

In some embodiments, the services provided by cloud infrastructure system 802 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 802. Cloud infrastructure system 802 then performs processing to provide the services in the customer's subscription order.

In some embodiments, the services provided by cloud infrastructure system 802 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and customizable services that can authenticate users and adapt to diverse needs of diverse organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various cloud applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 802 may also include infrastructure resources 830 for providing the resources used to provide various services to customers of the cloud infrastructure system. In one embodiment, infrastructure resources 830 may include pre-integrated and optimized combinations of hardware, such as servers, storage, and networking resources to execute the services provided by the PaaS platform and the SaaS platform.

In some embodiments, resources in cloud infrastructure system 802 may be shared by multiple users, and the resources can be re-allocated based on demand. Additionally, resources may be allocated to users in different time zones. For example, cloud infrastructure system 830 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 832 may be provided that are shared by different components or modules of cloud infrastructure system 802 and by the services provided by cloud infrastructure system 802. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 802 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 802, and the like.

In one embodiment, as depicted in the figure, cloud management functionality may be provided by one or more modules, such as an order management module 820, an order orchestration module 822, an order provisioning module 824, an order management and monitoring module 826, and an identity management module 828. These modules may include or be provided using one or more computers and/or servers, which may be general purpose computers, special purpose computers, specialized server computers, server farms, server clusters, or any other appropriate arrangement and/or combination.

In operation 834, a customer using a client device, such as client device 804, 806 or 808, may interact with cloud infrastructure system 802 by requesting one or more services provided by cloud infrastructure system 802 and placing an order for a subscription for one or more services offered by cloud infrastructure system 802. In certain embodiments, the customer may access a cloud User Interface (UI), cloud UI 812, cloud UI 814 and/or cloud UI 816 and place a subscription order via these UIs. The order information received by cloud infrastructure system 802 in response to the customer placing an order may include information identifying the customer and one or more services offered by the cloud infrastructure system 802 that the customer intends to subscribe to.

After an order has been placed by the customer, the order information is received via the cloud UIs, 812, 814 and/or 816.

At operation 836, the order is stored in order database 818. Order database 818 can be one of several databases operated by cloud infrastructure system 818 and operated in conjunction with other system elements.

At operation 838, the order information is forwarded to an order management module 820. In some instances, order management module 820 may be configured to perform billing and accounting functions related to the order, such as verifying the order, and upon verification, booking the order.

At operation 840, information regarding the order is communicated to an order orchestration module 822. Order orchestration module 822 may utilize the order information to orchestrate the provisioning of services and resources for the order placed by the customer. In some instances, order orchestration module 822 may orchestrate the provisioning of resources to support the subscribed services using the services of order provisioning module 824.

In certain embodiments, order orchestration module 822 enables the management of processes associated with each order and applies logic to determine whether an order should proceed to provisioning. At operation 842, upon receiving an order for a new subscription, order orchestration module 822 sends a request to order provisioning module 824 to allocate resources and configure those resources needed to fulfill the subscription order. Order provisioning module 824 enables the allocation of resources for the services ordered by the customer. Order provisioning module 824 provides a level of abstraction between the cloud services provided by cloud infrastructure system 800 and the physical implementation layer that is used to provision the resources for providing the requested services. Order orchestration module 822 may thus be isolated from implementation details, such as whether or not services and resources are actually provisioned on the fly or pre-provisioned and only allocated/assigned upon request.

At operation 844, once the services and resources are provisioned, a notification of the provided service may be sent to customers on client devices 804, 806 and/or 808 by order provisioning module 824 of cloud infrastructure system 802.

At operation 846, the customer's subscription order may be managed and tracked by an order management and monitoring module 826. In some instances, order management and monitoring module 826 may be configured to collect usage statistics for the services in the subscription order, such as the amount of storage used, the amount data transferred, the number of users, and the amount of system up time and system down time.

In certain embodiments, cloud infrastructure system 800 may include an identity management module 828. Identity management module 828 may be configured to provide identity services, such as access management and authorization services in cloud infrastructure system 800. In some embodiments, identity management module 828 may control information about customers who wish to utilize the services provided by cloud infrastructure system 802. Such information can include information that authenticates the identities of such customers and information that describes which actions those customers are authorized to perform relative to various system resources (e.g., files, directories, applications, communication ports, memory segments, etc.) Identity management module 828 may also include the management of descriptive information about each customer and about how and by whom that descriptive information can be accessed and modified.

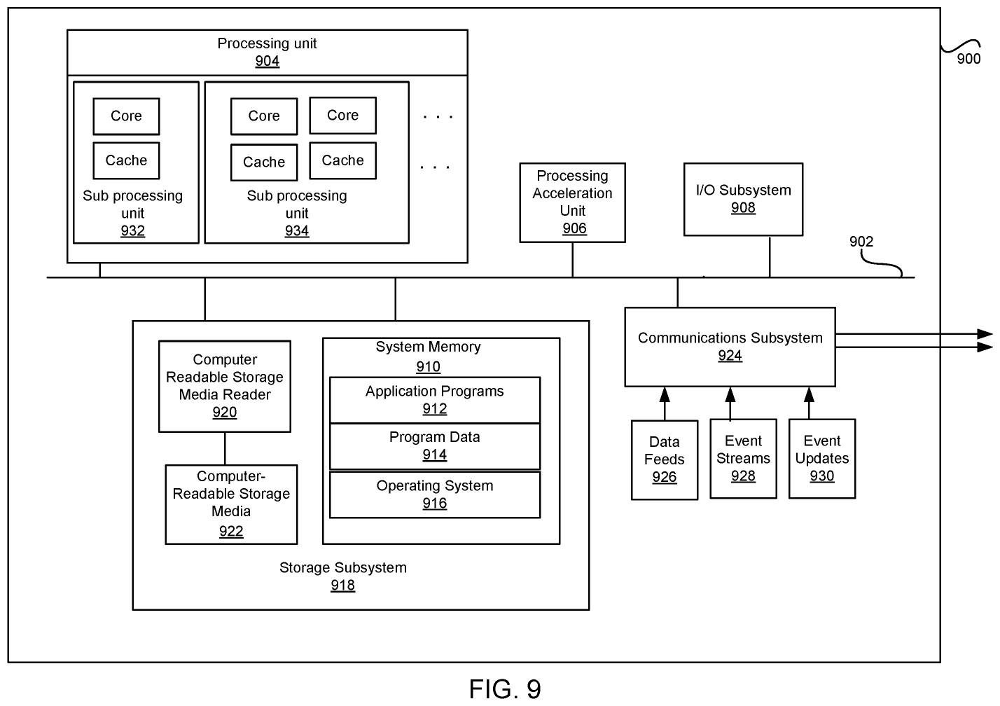

FIG. 9 illustrates an example of a computer system 900, in which various embodiments of the present invention may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present invention.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 1202.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### Examples

With respect to each of multiple exemplary data sets, item-source metrics corresponding to four sources are transformed into both standard-normalized item-source metrics (in accordance with Eqn. 2) and stretch-normalized item-source metrics (in accordance with Eqn. 2). Across the examples corresponding to Tables 1-5 and 8, the target range is 10-100. (The target ranges for Tables 6 and 7 are 10-200 and 70-100, respectively.) The range of the item-source metrics vary across the tables.

Table 1 shows an exemplary a first exemplary data set. In this situation, the initial scores may have a modest difference in item-provision characteristics associated with different sources. The item-source metrics range from 50-80, the standard normalized item-source metrics range from 1-100, and the stretch-normalized item-source metrics range from 66.3-100. Thus, the range between the stretch-normalized item-source metrics (a range of 33.7) is much closer to the range of the item-source metrics (range of 30), relative to an extent to which the range of the standard normalized item-source metrics (range of 90) compares to the range of the item-source metrics (range of 30).

### Normal Data:

TABLE 1

| | Item-Source | Standard Normalized | Stretch-Normalized |
|---|---|---|---|
| Supplier | Metric | Item-Source Metric | Item-Source Metric |
| S1 | 65 | 55.0 | 83.1 |
| S2 | 80 | 100.0 | 100.0 |
| S3 | 70 | 70.0 | 88.8 |
| S4 | 50 | 10.0 | 66.3 |

| | |
|---|---|
| S_min | 50 |
| S_max | 80 |
| R_min | 10 |
| R_max | 100 |

Table 2 shows an exemplary a second exemplary data set. In this situation, the spread across the initial scores is small (with a range of 9). The stretch-normalized item-source metrics similarly includes a relatively small spread (11.7), whereas the standard normalized item-source metric has a maximum spread (90). Thus, the standard normalized item-source metrics could not be used to differentiate a situation where all suppliers corresponding to similar metrics reflecting similar quality in terms of priorities versus a situation where a very drastic difference is present in this regard. Meanwhile, stretch-normalized item-source metrics can capture this difference.

### Small-Range Data:

TABLE 2

| | Item-Source | Standard Normalized | Stretch-Normalized |
|---|---|---|---|
| Supplier | Metric | Item-Source Metric | Item-Source Metric |
| S1 | 60 | 10.0 | 88.3 |
| S2 | 64 | 50.0 | 93.5 |
| S3 | 69 | 100.0 | 100.0 |
| S4 | 63 | 40.0 | 92.2 |

| | |
|---|---|
| S_min | 60 |
| S_max | 69 |
| R_min | 10 |
| R_max | 100 |

Table 3 shows an exemplary a third exemplary data set. In this situation, the initial scores are high. This may reflect a situation where all four sources are performing rather well. In the stretch-normalized circumstance, the metrics are within a middle to top of a range. However, in the standard-normalized circumstance, one of the scores is assigned to an absolute minimum of 10. This may be particularly alarming to a user and/or lead to a very poor overall source score or combined score, even though such a harsh summarization may not have been warranted.

### High-Value Data:

TABLE 3

| | Item-Source | Standard Normalized | Stretch-Normalized |
|---|---|---|---|
| Supplier | Metric | Item-Source Metric | Item-Source Metric |
| S1 | 230 | 88.0 | 82.8 |
| S2 | 250 | 100.0 | 100.0 |
| S3 | 100 | 10.0 | 46.0 |
| S4 | 150 | 40.0 | 64.0 |

| | |
|---|---|
| S_min | 100 |
| S_max | 250 |
| R_min | 10 |
| R_max | 100 |

Table 4 shows an exemplary a fourth exemplary data set. In this situation, the initial scores are low, though that may be due to a different scale or different realistic range applying to a corresponding item. The stretch-normalized item-source metrics continue to better capture the relative differences between the score, relative to the standard-normalized item-source metrics.

### Low-Value Data:

TABLE 4

| | Item-Source | Standard Normalized | Stretch-Normalized |
|---|---|---|---|
| Supplier | Metric | Item-Source Metric | Item-Source Metric |
| S1 | 2 | 10.0 | 28.0 |
| S2 | 3 | 21.3 | 37.0 |
| S3 | 5 | 43.8 | 55.0 |
| S4 | 10 | 100.0 | 100.0 |

| | |
|---|---|
| S_min | 2 |
| S_max | 10 |
| R_min | 10 |
| R_max | 100 |

Table 5 shows an exemplary a fifth exemplary data set. In this situation, the initial scores spread a very large range. Both of the standard normalized item-source metrics and the stretch-normalized item-source metrics capture this variability.

### Wide-Range Data:

TABLE 5

| | Item-Source | Standard Normalized | Stretch-Normalized |
|---|---|---|---|
| Supplier | Metric | Item-Source Metric | Item-Source Metric |
| S1 | 2 | 10.0 | 12.0 |
| S2 | 3 | 11.0 | 13.0 |
| S3 | 10 | 18.2 | 20.0 |
| S4 | 90 | 100.0 | 100.0 |

| | |
|---|---|
| S_min | 2 |
| S_max | 90 |
| R_min | 10 |
| R_max | 100 |

Table 6 shows an exemplary a sixth exemplary data set. In this situation, the target range extends from 10 to 200 (instead of 10 to 100). The stretch normalization results in the item-source metrics from extending to the maximum of the range (200), whereas the standard normalized item-source metrics extend to only about ⅔ of the maximum of the range.

### Large-Target-Range Data:

TABLE 6

| | Item-Source | Standard Normalized | Stretch-Normalized |
|---|---|---|---|
| Supplier | Metric | Item-Source Metric | Item-Source Metric |
| S1 | 65 | 105.0 | 164.4 |
| S2 | 80 | 200.0 | 200.0 |
| S3 | 70 | 136.7 | 176.3 |
| S4 | 50 | 10.0 | 128.8 |

| | |
|---|---|
| S_min | 50 |
| S_max | 80 |
| R_min | 10 |
| R_max | 200 |

Table 7 shows an exemplary a seventh exemplary data set. In this situation, the initial scores cover a high range but also have a minimum value that is relatively high. In this circumstance, the spread of the standard normalized item-source metrics fails to indicate the extent of variation amongst the metrics, whereas this is captured in the stretch-normalized item-source metrics.

Target with High Min Range:

TABLE 7

| | Item-Source | Standard Normalized | Stretch-Normalized |
|---|---|---|---|
| Supplier | Metric | Item-Source Metric | Item-Source Metric |
| S1 | 65 | 86.25 | 70.0 |
| S2 | 120 | 100.0 | 100.0 |
| S3 | 70 | 87.5 | 72.7 |
| S4 | 50 | 82.5 | 34.5 |

| | |
|---|---|
| S_min | 50 |
| S_max | 120 |
| R_min | 70 |
| R_max | 100 |

Table 8 shows an exemplary an eighth exemplary data set. In this situation, the initial scores are particularly high. The stretch-normalized item-source metrics reflect the fact that the four scores are high, whereas the standard normalized item-source metrics would seem to represent a massive difference across the sources.

Small Range with High Values Data:

TABLE 8

| | Item-Source | Standard Normalized | Stretch-Normalized |
|---|---|---|---|
| Supplier | Metric | Item-Source Metric | Item-Source Metric |
| S1 | 220 | 10.0 | 97.2 |
| S2 | 225 | 74.3 | 99.2 |
| S3 | 227 | 100.0 | 100.0 |
| S4 | 223 | 48.6 | 98.4 |

| | |
|---|---|
| S_min | 220 |
| S_max | 227 |
| R_min | 10 |
| R_max | 100 |

In the present specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method including:
receiving, from a requestor system, a natural-language query that includes, for each item of a set of items, a natural-language identification of the item;
mapping, for each item of the set of items, the natural-language identification of the item to an item category using an artificial-intelligence model that includes a natural language processing model;
identifying a set of sources, wherein each source of the set of sources is configured to, for at least one item of the set of items, provide an item that corresponds to an item category mapped to the item;
determining one or more target ranges for source scores, wherein each target range of the one or more target ranges is from a corresponding target-range minimum to a corresponding target-range maximum;
for each source of the set of sources:
determining, for each item of the at least one of the set of items that the source is configured to provide, an item-source metric that predicts a degree to which a predicted provision of the item by the source accords with requestor priorities of a provision of the item, wherein the item-source metric includes a number within an item-score range;
transforming, for each item of the at least one of the set of items that the source is configured to provide, the item-source metric to a stretch-normalized item-source metric by generating a product of the item-source metric and a stretched-normalization factor that is based on a ratio of a size of a target range of the one or more target ranges relative to a maximum of the item-source metrics across the set of sources; and
generating a source score using the stretched-normalization item-source metrics associated with the source;
generating a response to the query based on the source scores; and
outputting the response to the query.

2. The computer-implemented method of claim 1, further comprising:
receiving, via an interface, input from the requestor system that indicates a relative priority of a source characteristic for evaluating the set of sources, wherein the source score generated for each source of the set of sources is further based on the relative priority of the source characteristic.

3. The computer-implemented method of claim 1, wherein the degree to which the predicted provision of the item by the source accords with the requestor priorities of the provision of the item is based on a degree to which the item that the source is configured to provide is the same as the item identified in the set of items.

4. The computer-implemented method of claim 1, wherein the degree to which the predicted provision of the item by the source accords with the requestor priorities of the provision of the item is based on a predicted probability of the item being available for the source to transport, the predicted probability being based on empirical indications as to whether or with what delay another item of a same type was received from the source by another requester.

5. The computer-implemented method of claim 1, wherein the degree to which the predicted provision of the item by the source accords with the requestor priorities of the provision of the item is determined by generating, using a machine-learning model, a predicted requestor rating of provision of the item by the source.

6. The computer-implemented method of claim 1, further comprising:
ranking the set of sources based on the source scores, wherein the response includes an identification of the set of sources and the ranking of the set of sources.

7. The computer-implemented method of claim 1, further comprising:
ranking the set of sources based on the source scores; and
determining an incomplete subset of the set of sources, wherein the response includes an identification of the incomplete subset of the set of sources.

8. The computer-implemented method of claim 1, wherein a quantity of items in the at least one item of the set of items that a first source of the set of sources is configured to provide is different than a quantity of items in the at least one item of the set of items that a second source of the set of sources is configured to provide, and wherein the response to the query indicates which items of the set of items that the first source is configured to provide and which items of the set of items that the second source is configured to provide.

9. The computer-implemented method of claim 1, further comprising, for each source of the set of sources:
for each item of any items that are in the set of items but for which the source is not configured to provide:
assigning a default value as a stretch-normalized item-source metric, wherein the default value is a predefined constant or is based on the stretch-normalized item-source metrics associated with one or more other sources of the set of sources and associated with the item; and
wherein generating the source score includes: generating a statistic based on the stretch-normalized item-source metrics for the set of items.

10. The computer-implemented method of claim 1, wherein, for each source of the set of sources, the source score generated for the source is selectively based on the at least one of the set of items that the source is configured to provide.

11. The computer-implemented method of claim 1, wherein the transformation of the item-source metric to the stretch-normalized item source metric does not use a minimum of the item-source metrics across the set of sources.

12. A system comprising:
one or more data processors; and
a non-transitory computer readable storage medium containing instructions which, when executed on the one or more data processors, cause the one or more data processors to perform a set of actions including:
receiving, from a requestor system, a natural-language query that includes, for each item of a set of items, a natural-language identification of the item;
mapping, for each item of the set of items, the natural-language identification of the item to an item category using an artificial-intelligence model that includes a natural language processing model;
identifying a set of sources, wherein each source of the set of sources is configured to, for at least one of the set of items, provide an item that corresponds to an item category mapped to the item;
determining one or more target ranges for source scores, wherein each target range of the one or more target ranges is from a corresponding target-range minimum to a corresponding target-range maximum;
for each source of the set of sources:
determining, for each item of the at least one of the set of items that the source is configured to provide, an item-source metric that predicts a degree to which a predicted provision of the item by the source accords with requestor priorities of a provision of the item, wherein the item-source metric includes a number within an item-score range;
transforming, for each item of the at least one of the set of items that the source is configured to provide, the item-source metric to a stretch-normalized item-source metric by generating a product of the item-source metric and a stretched-normalization factor that is based on a ratio of a size of a target range of the one or more target ranges relative to a maximum of the item-source metrics across the set of sources; and
generating a source score using the stretched-normalization item-source metrics associated with the source;
generating a response to the query based on the source scores; and
outputting the response to the query.

13. The system of claim 12, wherein the set of actions further includes:
receiving, via an interface, input from the requestor system that indicates a relative priority of a source characteristic for evaluating the set of sources, wherein the source score generated for each source of the set of sources is further based on the relative priority of the source characteristic.

14. The system of claim 12, wherein the degree to which the predicted provision of the item by the source accords with the requestor priorities of the provision of the item is based on a degree to which the item that the source is configured to provide is the same as the item identified in the set of items.

15. The system of claim 12, wherein the degree to which the predicted provision of the item by the source accords with the requestor priorities of the provision of the item is based on a predicted probability of the item being available for the source to transport, the predicted probability being based on empirical indications as to whether or with what delay another item of a same type was received from the source by another requester.

16. The system of claim 12, wherein the degree to which the predicted provision of the item by the source accords with the requestor priorities of the provision of the item is determined by generating, using a machine-learning model, a predicted requestor rating of provision of the item by the source.

17. The system of claim 12, wherein the set of actions further includes:
ranking the set of sources based on the source scores, wherein the response includes an identification of the set of sources and the ranking of the set of sources.

18. A computer-program product tangibly embodied in a non-transitory machine-readable storage medium, including instructions configured to cause one or more data processors to perform a set of actions including:
receiving, from a requestor system, a natural-language query that includes, for each item of a set of items, a natural-language identification of the item;
mapping, for each item of the set of items, the natural-language identification of the item to an item category using an artificial-intelligence model that includes a natural language processing model;
identifying a set of sources, wherein each source of the set of sources is configured to, for at least one of the set of items, provide an item that corresponds to an item category mapped to the item;
determining one or more target ranges for source scores, wherein each target range of the one or more target ranges is from a corresponding target-range minimum to a corresponding target-range maximum;
for each source of the set of sources:
determining, for each item of the at least one of the set of items that the source is configured to provide, an item-source metric that predicts a degree to which a predicted provision of the item by the source accords with requestor priorities of a provision of the item, wherein the item-source metric includes a number within an item-score range;
transforming, for each item of the at least one of the set of items that the source is configured to provide, the item-source metric to a stretch-normalized item-source metric by generating a product of the item-source metric and a stretched-normalization factor that is based on a ratio of a size of a target range of the one or more target ranges relative to a maximum of the item-source metrics across the set of sources; and
generating a source score using the stretched-normalization item-source metrics associated with the source;
generating a response to the query based on the source scores; and
outputting the response to the query.

19. The computer-program product of claim 18, wherein the set of actions further includes:
receiving, via an interface, input from the requestor system that indicates a relative priority of a source characteristic for evaluating the set of sources, wherein the source score generated for each source of the set of sources is further based on the relative priority of the source characteristic.

20. The computer-program product of claim 18, wherein the degree to which the predicted provision of the item by the source accords with the requestor priorities of the provision of the item is based on a degree to which the item that the source is configured to provide is the same as the item identified in the set of items.
